(19) United States
(12) Patent Application Publication
(10) Pub. No.: US 2013/0153400 A1
(43) Pub. Date: Jun. 20, 2013

(54) Regeneration of Capture Medium

(71) Applicants: Scott Alexander Hume, Renfrew (GB); Agnieszka Magdalena Kuczynska, Renfrew (GB)

(72) Inventors: Scott Alexander Hume, Renfrew (GB); Agnieszka Magdalena Kuczynska, Renfrew (GB)

(21) Appl. No.: 13/516,187

(22) PCT Filed: Dec. 17, 2010
(86) PCT No.: PCT/GB2010/052124

§ 371 Date: Aug. 17, 2012

(30) Foreign Application Priority Data
Dec. 18, 2009 (GB) 0922140.9

(51) Int. Cl. B01D 1/28

(52) U.S. Cl. CPC B01D 1/2856
USPC 203/26; 202/202; 202/173; 202/185.1; 202/180; 60/676

(57) ABSTRACT

An apparatus and method for the regeneration of absorbed gas rich capture medium such as an absorption solution and the recovery of absorbed gas therefrom, an apparatus and method for the removal and recovery of a target gas from a gas stream, and the use of the same for post combustion carbon capture on a thermal power plant are described. The apparatus and method make use of a regenerative heating process. The apparatus and method are distinctly characterized by the use of CRH steam as a source of thermal energy for the heating process.

The invention relates to a method and apparatus for the regeneration of a capture medium of the type used in an industrial process for the removal of constituents from a gas phase by absorption/adsorption and like processes. The invention for example relates to the regeneration of a medium used for the removal and capture of acid gases such as carbon dioxide from a gas phase through a solution absorption and regeneration processes. The invention relates particularly to the regeneration of absorption solution during the regeneration process. The invention is particularly suitable for application in an aqueous absorption and regeneration system for removing CO₂ from the flue gases of thermal power plants fired by carbonaceous fossil fuels, both as new build and for retrofitting into existing capture systems.

Most of the energy used in the world today is derived from the combustion of fossil fuels, such as coal, oil, and natural gas. Post-combustion carbon capture (PCC) is a means of mitigating the effects of fossil fuel combustion emissions by capturing CO₂ from large sources of emission such as thermal power plants which use fossil fuel combustion as the power source. The CO₂ is not vented to atmosphere but is removed from flue gases by a suitable absorber and stored away from the atmosphere. Other industrial processes where similar principles might be applicable to capture post-process CO₂ might include removal of CO₂ generated in a process cycle, for example removal of CO₂ from the process flow during production of ammonia, removal of CO₂ from a natural gas supply etc.

It is known that CO₂ can be separated from a gas phase, for example being the flue gas of a thermal power plant, by means of absorption by passing the gas through a column where the gas flows in an opposite direction to a capture medium in the form of an absorbent in liquid phase, typically in aqueous solution. Such a process is sometimes referred to as wet scrubbing. A well known absorbent reagent comprises one or more amines in water.

Gas is passed through the absorption solution under conditions of pressure and temperature optimised for removal of substantially all the carbon dioxide into the absorption solution. The purified gas emerges at the top of the absorption column and is then directed for further processing as necessary. The absorption solution rich in CO₂ is drawn off at the foot of the absorption column and subjected to a stripping process to remove the CO₂ and regenerate the absorption solution.

To effect this the CO₂ rich solution is passed onwards to a suitable apparatus for recovery of the gas and regeneration of the solution. Typically this process involves regenerative heating of the solution, for example through successive cycles of reheating and for example by means of a reboiler. The CO₂ rich solution is for example introduced into a regeneration column, and maintained at high temperature, which may be at or near boiling point under pressure. The heat necessary for the reboiler is typically obtained when the system is used in association with a thermal power plant by supplying the reboiler with a proportion of the steam from the LP turbine system. At higher temperatures the solution will release the absorbed CO₂. Regenerated solution may be drawn off for reuse in the absorption column. Vapour containing the stripped CO₂ and also typically comprising water vapour and solvent vapour emerges at the top of the regeneration column and is passed through a condenser system which condenses the vapour and returns the liquids to the regeneration column. The released CO₂ may then be collected for example for sequestration.

Solid media may also be considered where appropriate to the application where a target gas is selectively adsorbed/absorbed by a solid phase capture medium, whether formed as an active species on passive carrier or via a solid that is directly active. Some carbon capture systems based on amine or similar chemistry stabilise an active sorbent on solid carriers instead of in solution. Solid adsorbent capture systems based on the use of cyclic adsorption/desorption processes with immoblised amines or other CO₂-binding materials held on solid supports such as activated carbons, zeolites or other fine tailored alumina, silica, zirconia or their combinations are seen as a possible next generation carbon capture technology. Generally similar principles are likely to be applied to the regeneration of such solid capture media.

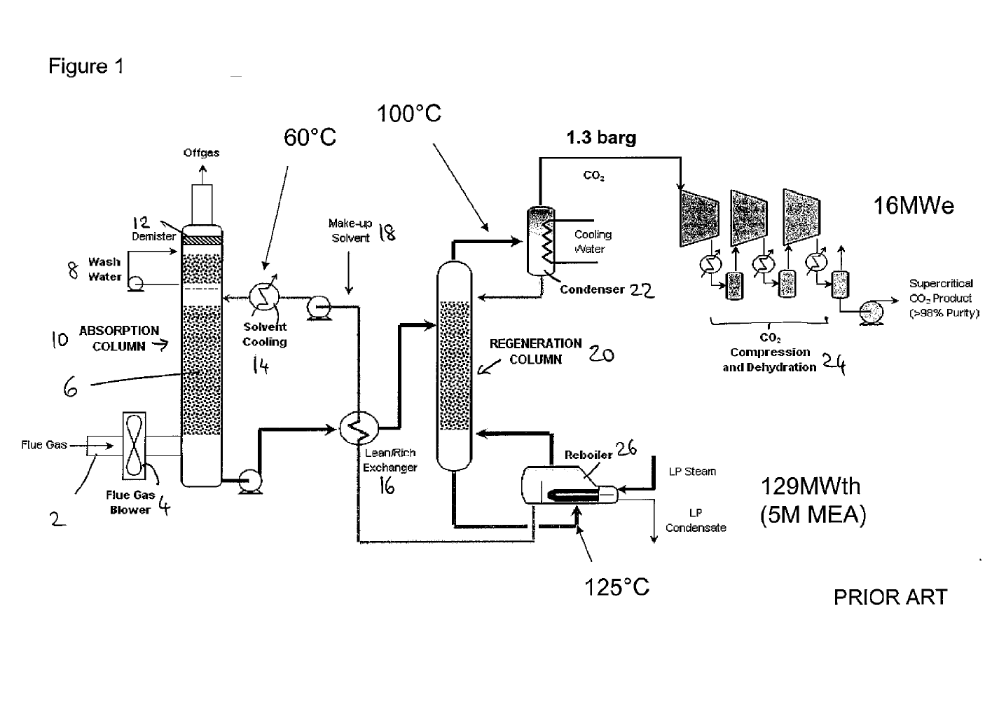

A schematic of a known absorption and recovery apparatus as above described is shown in FIG. 1.

A problem with the existing absorption and recovery process described above is that it can be very energy intensive. The energy requirement arises in large part because of the heat required for the reboiler. In application on a thermal power plant, the required reboiler heat can reduce net power production by as much as 15% or more.

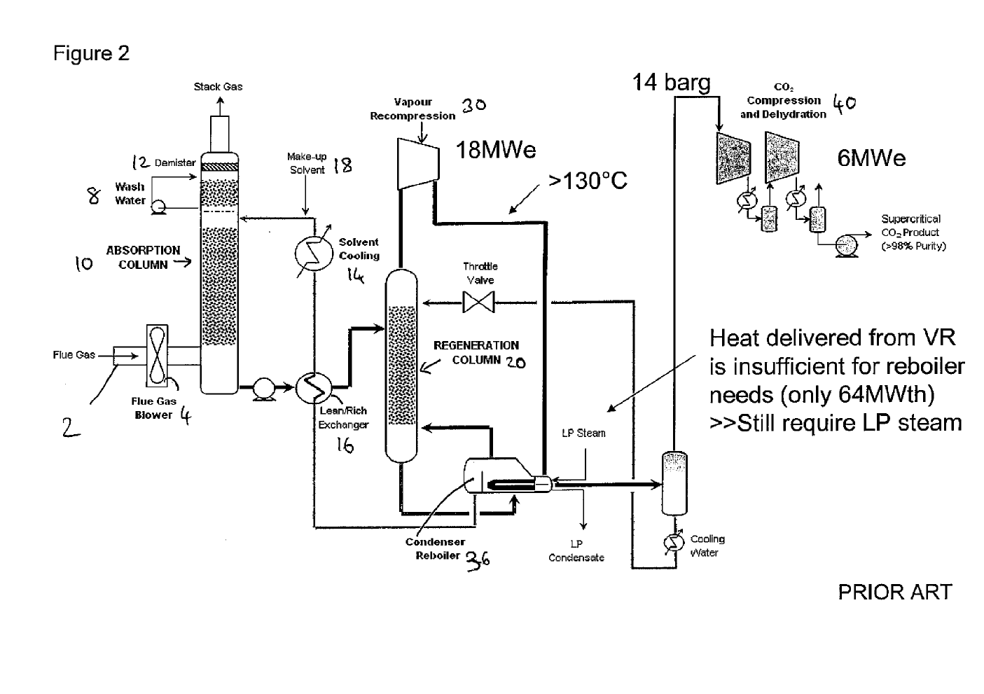

It is known to improve the energy efficiency of the process by making use of vapour recompression to recover useful heat from the vapour/CO₂ stream. The vapour/CO₂ stream from the regeneration column is compressed and then used to provide heat for the reboiler. A schematic of an absorption and recovery apparatus incorporating such a modification is shown in FIG. 2.

However, in a typical configuration in a thermal power plant the heat delivered from vapour recompression is insufficient for the total reboiler requirement. As can be seen in FIG. 2 the system still requires some LP steam to make up the deficiency.

In accordance with the invention in a first aspect there is provided an apparatus for the regeneration of a capture medium rich in a captured target gas such as an absorbed gas rich absorption solution and the recovery of captured gas therefrom comprising:

a containment structure defining a process volume;

a supply conduit to pass captured gas rich capture medium into the process volume;

condensing heating means fluidly connected to the process volume to heat the gas rich capture medium and thereby cause captured gas to dissociate into a gas rich vapour phase;

a vapour recompression system fluidly connected to the process volume to receive vapour output from the process volume and to compress the same;

a compressed vapour supply conduit to supply output compressed vapour to the heating means as a source of thermal energy therefor;

a secondary source of thermal energy for the heating means comprising, fluidly in series:
a receiving conduit for receiving cold reheat steam from a thermal power plant;
a back pressure turbine disposed to drive the vapour compression system to extract work from and reduce the pressure of the cold reheat steam;
a delivery conduit to deliver the resultant lower pressure steam to the heating means as a further source of thermal energy therefor.

The apparatus of the invention is thus an apparatus for the regeneration of capture medium and in the preferred case absorption solution, most of the features of which will be familiar from the prior art.

As will be understood, the apparatus of the invention comprises an apparatus for the regeneration of capture medium by removal of a target gas species previously associated therewith, for example having been previously associated therewith in a suitable capture apparatus in which a gas phase containing the target gas has been caused to flow through the capture medium. The capture medium may be any medium suitable for that purpose. The capture medium may be any medium with selective specificity to associate with a target gas, whether via physical or chemical absorption, adsorption or like processes, in particular to tend to associate at a first, lower process temperature and dissociate at a second, higher process temperature. The capture medium may thus be regenerated to recover captured target gas by heating.

The capture medium may be in any state, such as is in solid, fluidised solid or liquid state, that allows a gas phase containing the target gas to flow through it. The capture medium may comprise a material inherently able to associate with the target gas or may comprise a compound structure of an active ingredient so able to associate and a passive carrier.

In a preferred case the capture medium is for example an absorption solution from a wet scrubber. Many of the features of such systems will be familiar from the prior art. The invention is discussed below applied to a system for such an absorption solution but this is an example only of a possible system and capture medium to which the invention could be applied. References to an absorption solution by way of example will be thus understood as generally applicable to other capture media susceptible of regeneration to recover captured target gas in similar manner.

In such a case the containment structure defines a process volume which is for example an elongate column, for example disposed vertically. A solution comprising absorbent solvent which is rich in an absorbed target gas, for example from a suitable absorption column, is passed into the volume, for example towards the top of the regeneration column. The column preferably contains high surface area separation structures. Solution passing out of the volume, for example at the bottom of the column is, subject to a repeatedly cycled heating and for example reboiling process by the heating means in a manner which will be familiar. Thus, the heating means typically comprises a reboiler such as a condensing reboiler.

The result of this process is to cause the absorbed gas to tend to dissociate from the solution, and to result in the production of an absorbed gas rich vapour phase (for example further including water vapour, and solution vapour) which can be drawn from the process volume for example at the top of the column, and a lean regenerated solution which can be removed for reuse in an absorption system. Such an arrangement will be generally familiar from the prior art.

The invention is distinctly characterised in the two sources of thermal energy which are used to provide energy, and in the particular preferred case substantially all of the energy, necessary to drive the heating means.

First, the vapour stream rich in recovered formerly absorbed gas is subject to compression in a vapour recompression apparatus comprising one or more compressors. The heat recovered by this process is delivered to the heating means to supply some of its thermal energy requirement.

Such an arrangement alone is known. However, it is insufficient to meet the entire requirement of a typical reboiler. In prior art systems, a vapour recompression method can reduce the amount of LP steam required to provide energy for the reboiler, but cannot substitute for it. A substantial amount of LP steam energy is still required.

The present invention is distinctly characterised in that use is additionally made of cold reheat (CRH) steam in substitution, at least in part, for the residual LP steam. As will be well understood in the art, cold reheat steam comprises exhaust steam from a higher pressure turbine, for example from the HP turbine of a HP/IP/LP system, which is diverted from the reheat stream prior to being reheated to condition for supply to the next turbine in the system. The CRH steam is at higher pressure than the LP exhaust conventionally used, and is passed via a pressure reducing means comprising a means to extract work from and reduce the pressure of the CRH steam. The means to extract work comprises a drive for the vapour compression system in the form of a back pressure turbine disposed to drive the vapour compression system. Thus the CRH steam provides two functions. First, it provides useful mechanical work to drive the vapour recompression process via a back pressure turbine which is used to drive the vapour compression apparatus for example by suitable mechanically linked drive means. Second, the resultant lower pressure steam produced as output is supplied to the heating means as an additional source of thermal energy.

Making use of the CRH steam in this way to supply at least some, preferably a major part of, and particularly preferably substantially all of, the thermal energy deficit which cannot be supplied by vapour recompression alone substantially reduces, and in the preferred case can essentially obviate, the need to use steam from the LP system at all. This is achieved because of the distinctive combination of both CRH steam and vapour recompression to deliver each stream to the heating means at appropriate condition.

Advantages of such a dual delivery system include one or more of the following.

There is an ability to balance the input of required heat to the reboiler (i.e. balance the heat input from the vapour recompression and the cold reheat).

The plant may be easier to integrate into the turbine systems of a thermal power facility, for example removing the need for a large pressure maintenance value on the IP/LP cross over or requiring a special LP turbine with a clutch arrangement.

Gas delivered from the process tends to be at a higher elevated pressure (for example 5 bar) so downstream compression power requirements may be reduced.

The apparatus may further comprise a reflux condenser downstream of the heating means. Since the reflux condenser may be set up to reject heat to the heating means, the cooling water requirement may be reduced.

The heating means is for example a condenser reboiler as is familiar. Again as is familiar it is disposed to receive solution that has passed through a process volume, for example via an outlet towards the bottom of a column, and reboil the solution. The invention is distinctly characterised in that the energy for the reboiler is supplied at least in large part both by vapour recompression and from the lower pressure stream derived from CRH steam from the HP turbine system. This may significantly reduce or eliminate the need for a stream from the LP turbine system. Thus, in the preferred case, the regeneration apparatus may be further distinguished by the absence of any steam supply from the LP turbine system, steam supply being limited to CRH steam from the HP turbine system.

The vapour recompression apparatus may comprise a single compressor. Optionally, a plurality of compressors may be provided, for example in series, to compress the vapour. The vapour is compressed for example to 2 to 20 bar or higher if necessary.

The apparatus conveniently incorporates a condenser to condense and recover solution vapour from the compressed vapour phase. Conduit means may be provided to feed recovered solution condensed from the vapour phase to any suitable point in the system and for example back into the containment structure.

The apparatus conveniently incorporates a condenser to condense and recover water vapour from the vapour phase. Conduit means may be provided to deliver the recovered water to any suitable point in the system.

The resultant output is a substantially pure target gas phase, for example substantially pure CO₂ gas phase, suitable for subsequent storage. In a more complete system, the apparatus may further comprise fluidly in series a conduit to deliver the gas phase produced by the condensing heating means via optional additional condensing cooling means, for example as above described, optionally via a dehydration apparatus, to a compression system for storage. In the preferred case, where the recovered gas is CO₂, such a system is known to produce greater than 98% purity CO₂ for storage.

The regeneration apparatus is in particular intended for and is preferably adapted for use with an absorption apparatus such as an absorption column suitable for absorbing a target gas from a source gas stream into a suitable capture medium such as an absorption solution, producing a target gas rich solution which may then be passed to the regeneration apparatus of the first aspect of the invention for regeneration of capture medium and recovery of absorbed target gas therefrom.

Preferably, at least one regeneration apparatus as above described is provided for use with, and for example in fluid series downstream of, at least one such absorption apparatus.

Thus, in a more complete second aspect of the invention, an apparatus for removal of a target gas from a source gas stream comprises an absorption apparatus fluidly upstream of a regeneration apparatus in accordance with the first aspect of the invention. The absorption apparatus in particular comprises a means to absorb a target gas from a source gas stream into a suitable capture medium such as an absorption solution and for example is a means to countercurrently flow an absorption solution and a source gas stream so as to cause the target gas to pass into and be absorbed by the absorption solution. That is to say, the absorption apparatus for example comprises an absorption column or wet scrubber column as will be familiar.

Such an absorption column may for example comprise a containment vessel, and for example a vertical containment vessel, containing multiple sections of structured packaging to maximise the surface area for mass transfer. The gas stream inlet means may be provided, for example towards the bottom of the column, to inlet a gas stream including a target gas. Solution supply means may be provided, for example towards the top of a column, to provide lean absorption solution thereto. The gas stream flows upwards through the column as the absorption solution flows countercurrently downwards. Target gas is absorbed into the absorption solution and a target gas rich absorption solution is drawn off, for example at the bottom of the column. A rich absorption solution outlet is preferably provided for this purpose.

The apparatus preferably comprises a rich absorption solution conduit linking the rich absorption solution outlet to a rich absorption solution inlet of the regeneration apparatus of the first aspect of the invention. The apparatus preferably further comprises a lean absorption solution conduit to pass regenerated lean absorption solution from the regeneration apparatus to an absorption solution inlet of the absorption apparatus. The lean absorption solution conduit may include solution cooling means to cool the regenerated solution from the higher temperature at which it leaves the reboiler to a lower temperature more suitable for the absorption process.

The target gas is preferably an acid gas, and is especially CO₂. Preferred absorption solutions include aqueous solutions of suitable absorbent reagents. Systems for the recovery of CO₂ from a gas stream are well established, and suitable chemistries and absorbent reagents are well known. The solution may for example comprise one or more aqueous amines, for example including but not limited to monoethanolamines or methyl-diethanol-amines. However, the invention is not limited by chemistry, being applicable to any process where a gas rich absorption solution is regenerated thermally to recover the target gas and lean solution.

In a particularly convenient application of the invention, the source gas stream is flue gas from a combustion apparatus for the burning of carbonaceous fuels, such as flue gas from a thermal power plant.

It follows that in a more complete third aspect of the invention, there is provided a thermal power plant comprising a combustion means to burn carbonaceous fuel and generate steam, at least one high pressure (HP) turbine system and at least one low pressure (LP) turbine system, and optionally additional, for example intermediate pressure (IP), turbine system(s); a regeneration apparatus in accordance with the first aspect of the invention or a gas removal apparatus in accordance with the second aspect of the invention including such a regeneration apparatus; conduit means to supply cold reheat steam from a steam exhaust of the HP turbine system of the thermal power plant to the work extraction/pressure reduction means, for example being the back pressure turbine, of the regeneration apparatus.

The thermal power plant in accordance with this aspect of the invention is distinctly characterised in that a combination of vapour recompression and CRH steam is used to provide thermal energy to the heating means. This can substitute for the LP steam conventionally used, in the preferred case entirely. Thus, in the preferred case, the power plant may be further distinguished by the absence of any steam supply from the LP turbine system to the regeneration apparatus.

The power plant may optionally additionally comprise a flue gas outlet fluidly connected to supply flue gas directly from the combustion apparatus as a source gas stream to a removal apparatus of the second aspect of the invention.

In accordance with the invention in a fourth aspect there is provided a method of regeneration of capture medium rich in a captured target gas such as an absorption solution rich in absorbed gas and recovery of an absorbed gas therefrom comprising the steps of:

heating a target gas rich capture medium such as an absorption solution, in particular repeatedly, and in particular by reboiling, and thereby causing captured gas to dissociate into a gas rich vapour phase;

compressing the vapour phase and using the compressed vapour as a first source of thermal energy for heating the capture medium;

additionally taking a supply of cold reheat steam from a thermal power plant, reducing the pressure of the cold reheat steam and extracting work therefrom via a back pressure turbine disposed to drive the vapour compression system to compress the vapour phase in accordance with the foregoing step, by passing the cold reheat steam through a back pressure turbine so as to drive a compressor to compress the vapour phase in accordance with the foregoing step, and using the resultant lower pressure steam as a further source of thermal energy for heating the capture medium.

The method in particular comprises passing the gas rich capture medium such as an absorption solution through a regeneration apparatus as above described having a heating means to heat the gas rich capture medium such as an absorbent solution, in particular by reboiling, and thereby cause captured gas to dissociate into a gas rich vapour phase; wherein the compressed vapour is used to supply thermal energy to the heating means; and wherein

the resultant lower pressure steam is passed to the heating means as a further source of thermal energy therefor.

Thus, as above described, the cold reheat steam (CRH) is used first as a source of work to drive the recompression process and second as a source of recovered heat to supplement the thermal energy requirement of the heating means. The requirement to use LP steam can be reduced or eliminated.

Further stages of process will be understood by the description of the foregoing apparatus. In particular the gas regenerated by the foregoing method steps may be then be subject to condensation, for example to remove absorbent liquid vapour and/or water vapour, drying, compression/liquefaction stages, for example to pass on for onward storage.

The target gas for capture is for example an acid gas such as CO₂, which has for example being removed from a combustion gas stream such as a flue gas stream from a thermal power plant.

Thus, in accordance with a fifth aspect of the invention there is provided a method for the removal and recovery of a target gas from a gas stream which comprises the steps of:

capturing and for example absorbing a target gas from a source gas stream into a suitable capture medium such as an absorption solution by passing the source gas stream through lean capture medium so as to cause a target gas component of the gas stream to associate with the capture medium and for example be absorbed by the absorbent solution, for example by passing the gas stream through an absorbing apparatus comprising a means to countercurrently flow absorbent solution and gas; drawing off the resultant target gas rich capture medium;

processing the target gas rich capture medium in accordance with the fourth aspect of the invention.

The gas stream is especially combustion flue gas, for example thermal power plant flue gas, the gas being especially CO₂ the method being especially in a preferred case a method of removal and recovery for sequestration of CO₂ from a flue gas stream such as a thermal power plant flue gas stream.

Such a method is generally familiar, and the subject of well established techniques, apparatus and chemistries. The distinct feature of the method of the present invention in accordance with all aspects is the use of CRH steam both to drive vapour recompression, and to supplement the thermal energy supplied by vapour recompression at the heating means to reduce and potentially eliminate the need to use LP steam.

The invention will be now be described by way of example only with reference to FIGS. 1 to 3 of the accompanying drawings in which:

FIG. 1 is a simple schematic of a prior art absorption and regeneration system;

FIG. 2 is a simple schematic of an alternative prior art absorption and regeneration system including a vapour recompression capability;

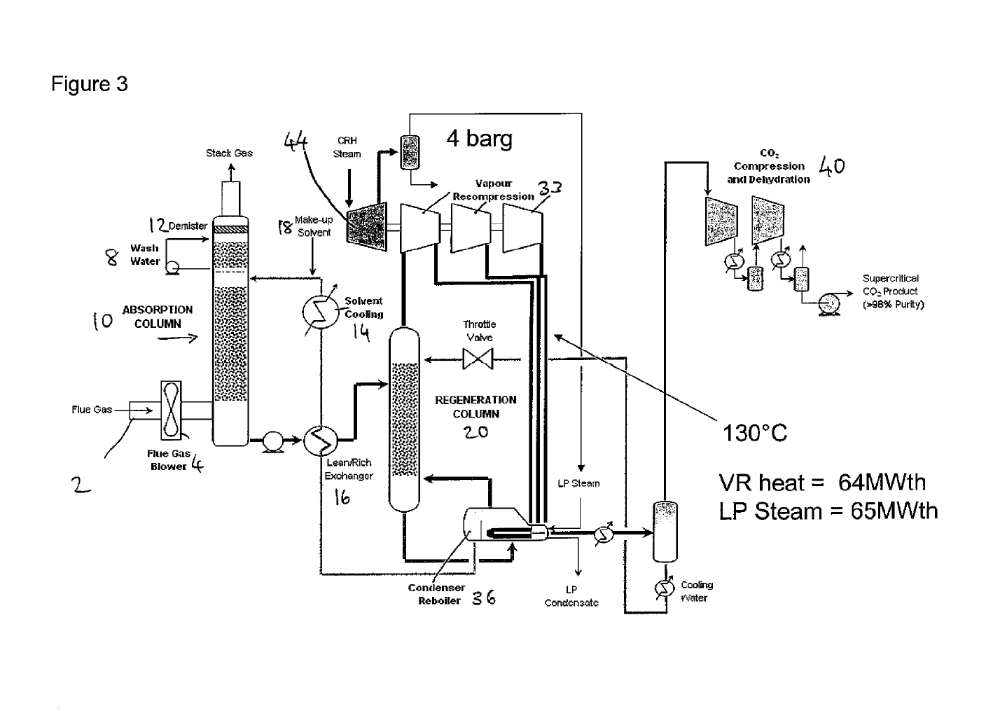

FIG. 3 is a simple schematic of an absorption and regeneration system embodying the principles of the invention.

Reference is made first to FIG. 1, which is a general schematic of a typical prior art system for the removal of CO₂ from flue gas via absorption, its recovery via regeneration, and its compression for sequestration.

Flue gas is supplied via a flue gas supply conduit 2 and flue gas blower 4 into the lower part of an absorption column 10. The absorption column is of any suitable design, and for example comprises a vessel containing structured packing 6 adapted to maximise surface area for exchange between liquid and gas and absorption of the CO₂ by the absorption liquid. It may contain other structures such as washing structures, demister etc as is conventional.

Solvent is introduced to an upper part of the column, for example from a fresh supply source and/or as lean solvent regenerated from the regeneration part of the system described below, and flows under the action of gravity countercurrently to the rising flue gas within the column. As this flow takes place, CO₂ is absorbed into the solvent in familiar manner.

The scrubbed flue gas progresses upwards through a washing structure, again comprising structured packing through which water is supplied countercurrently via the wash water supply 8, and passes via demister 12 out of the top of the column for onward processing. The CO₂ rich solvent passes to an outlet at the foot of the column and is passed via a suitable conduit through a solvent cooling stage 14 and a lean/rich solvent exchanger 16 and introduced to a regeneration column 20. A make up supply 18 may be added at this point.

As the temperature of the rich solvent is elevated, CO₂ previously absorbed is released. This generates a vapour phase which is rich in CO₂, and which additionally comprises some solvent vapour. The vapour phase is passed through a condenser 22 and condensed solvent vapour returned to the regeneration column 10. The resultant output gas, rich in CO₂, is passed to a compression and dehydration system 24 and the resultant high purity CO₂ product may be processed, for example for sequestration. The lean solvent is circulated through a reboiler 26 which is heated by LP steam from an associated thermal power plant (not shown). The regenerated lean solvent may be returned to the absorption column 10 for reuse.

The system represented in FIG. 1 is conventionally known in the art. It represents an effective solution to the problem of removal of CO₂ from flue gases in a thermal power plant, but can be quite energy intensive. The use of LP steam to drive the reboiler can reduce the efficiency of the thermal power plant significantly, perhaps by 15% or more.

An arrangement to mitigate this inefficiency to some extent is illustrated in FIG. 2.

The general principles of the system illustrated schematically in FIG. 2 upstream of the regeneration column are identical to those of FIG. 1 and like reference numerals are used where applicable. The apparatus of FIG. 2 differs in the way that the vapour phase removed from the top of the column is further processed. The vapour phase is subject to a vapour recompression 30 and the compressed and consequently heated vapour phase is passed via a condenser reboiler 36 to provide some of the thermal energy required for the reboiling process. The compressed vapour phase is then passed via a condenser to remove solvent vapour which is returned to the regeneration column. The relatively pure CO₂ is then passed on to a further compression and dehydration system 40. However, since the CO₂ is already under higher pressure as a result of the vapour recompression process, the energy required for subsequent compression prior to storage is reduced.

Such a system in known to offer potential increased efficiency. The recovery of energy from the system via the vapour recompression process can significantly reduce the thermal energy required to drive the reboiler. Although electrical energy is required to drive the compression apparatus, this can still represent an appreciable efficiency saving in a typical thermal power plant. Typical energy consumption figures are given on FIGS. 1 and 2 for example illustrative purposes.

However, in a system such as illustrated in FIG. 2 only some of the thermal energy required to drive the reboiler is provided by the vapour recompression process. By way of example illustration only, possible thermal energy contributions are suggested on the figure. On the basis of the example figures given, only 64 MWth of the 192 MWth energy input required is provided. The system therefore still requires LP steam to provide the shortfall, albeit in reduced quantities.

An equivalent system including an example embodiment of the present invention, which reduces and potentially eliminates entirely the need for supply of LP steam from the LP turbine system, is illustrated schematically in FIG. 3.

The absorption apparatus upstream of the regeneration column is not pertinent to the invention, may be conventional, and may be the same as that in FIGS. 1 and 2 and like reference numerals are used where applicable. The invention is characterised in two respects, first in the use of vapour recompression to provide some of the required thermal energy for the condenser reboiler and second in the use of CRH steam from the HP turbine system both to drive the vapour recompression and to provide (as low pressure steam) the additional thermal energy required for the condenser reboiler.

In accordance with the embodiment illustrated in FIG. 3, vapour produced by the regeneration process and drawn off from the top of the regeneration column is passed through successive compressors 33. Thermal energy from the compressed vapour is recovered to provide part of the thermal input required by the condenser reboiler 36. In the embodiment the vapour recompression process provides 64 MWth. The compressed vapour is passed through a condenser to remove solvent, which is returned to the regeneration column 20, and the resultant CO₂ rich gas processed by further compression and dehydration in the usual way.

The apparatus is particularly characterised in that it is additionally provided with a supply of CRH steam from the HP turbine system. In the preferred case, as is illustrated in the embodiment, this is in entire substitution for the supply of LP steam required by the system of FIG. 2. The CRH steam is passed via a back pressure turbine 44 which is mechanically arranged to drive the array of compression turbines making up the vapour recompression system 33. In addition to providing this driving impulse, the resultant lower pressure output is used as a supply of low pressure steam to the condenser reboiler 36. This lower pressure steam can substitute, at least in part, and preferably entirely, for the low pressure steam from the LP turbine system in the prior art represented by FIGS. 1 and 2. For example, in the illustrated embodiment, the lower pressure steam supplied in this way contributes 65 MWth energy, making up the shortfall from that provided by the vapour recompression.

Thus, in accordance with the invention the CRH steam supply and the vapour recompression system are integrated in a distinct and innovative way to deliver two heat streams to the reboiler at appropriate condition.

Advantages of such an arrangement may include:
An ability to balance the required heat to the reboiler
A PCC plant that avoids many of the problems of integration with the turbine system encountered in conventional arrangements, negating the need for a large pressure maintenance valve on the IP/LP crossover or indeed having a special LP turbine with a clutch arrangement.
CO₂ delivered from this process is at a higher elevated pressure (5 bara), so further compression power requirements are reduced (in the illustrated embodiment. the first stage of the conventional compression train is removed).
Since the reflux condenser rejects heat to the reboiler, the need for cooling water is substantially reduced.

1. An apparatus for the regeneration of a capture medium rich in a captured target gas and the recovery of absorbed gas therefrom comprising:
a containment structure defining a process volume;
supply conduit to pass captured gas rich capture medium into the process volume;
condensing heating means fluidly connected to the process volume to heat the gas rich capture medium and thereby cause captured gas to dissociate into a gas rich vapour phase; a vapour recompression system fluidly connected to the process volume to receive vapour output from the process volume and to compress the same;
a compressed vapour supply conduit to supply output compressed vapour to the heating means as a source of thermal energy therefor;
a secondary source of thermal energy for the heating means comprising, fluidly in series:
a receiving conduit for receiving cold reheat (CRH) steam from a thermal power plant;
a back pressure turbine disposed to drive the vapour compression system to extract work from and reduce the pressure of the cold reheat steam;
a delivery conduit to deliver the resultant lower pressure steam to the heating means as a further source of thermal energy therefor.

2. An apparatus in accordance with claim 1 wherein the heating means is adapted to subject the captured gas rich capture medium to a repeatedly cycled heating.

3. An apparatus in accordance with claim 2 wherein the heating means is a condensing reboiler.

4. An apparatus in accordance with claim 1 further characterized by the absence of any steam supply from the LP turbine system, steam supply being limited to CRH steam from the HP turbine system.

5. An apparatus in accordance with claim 1 wherein the vapour recompression apparatus comprises a plurality of compressors in series.

6. An apparatus in accordance with claim 1 wherein the vapour recompression apparatus is adapted to compress the vapour to a pressure of 2 to 20 bar.

7. An apparatus in accordance with claim 1 further comprising a condenser to condense and recover solution vapour from the compressed vapour phase.

8. An apparatus in accordance with claim 1 further comprising a condenser to condense and recover water vapour from the vapour phase.

9. An apparatus in accordance with claim 1 further comprising fluidly in series a conduit to deliver the gas phase produced by the condensing heating means via condensing cooling means and a dehydration apparatus to a compression system for storage.

10. An apparatus in accordance with claim 1 adapted for use with an absorption apparatus suitable for absorbing a target gas from a source gas stream into a suitable capture medium, producing a target gas rich capture medium which may then be passed to the regeneration apparatus for regeneration of capture medium and recovery of absorbed target gas therefrom.

11. An apparatus for removal of a target gas from a source gas stream comprising an absorption apparatus fluidly upstream of a regeneration apparatus as recited in claim 1.

12. An apparatus in accordance with claim 11 wherein the absorption apparatus comprises a means to absorb a target gas from a source gas stream into a suitable capture medium.

13. An apparatus in accordance with claim 12 wherein the absorption apparatus comprises a means to countercurrently flow an absorption solution and a source gas stream so as to cause the target gas to pass into and be absorbed by the absorption solution.

14. An apparatus in accordance with claim 11 wherein the source gas stream is flue gas from a combustion apparatus for the burning of carbonaceous fuels, such as flue gas from a thermal power plant.

15. A thermal power plant comprising a combustion means to burn carbonaceous fuel and generate steam, at least one high pressure (HP) turbine system and at least one low pressure (LP) turbine system; a regeneration apparatus in accordance with claim 1 or a gas removal apparatus in accordance with claim 11 including such a regeneration apparatus; conduit means to supply cold reheat steam from a steam exhaust of the HP turbine system to the work extraction means of the regeneration apparatus.

16. A thermal power plant in accordance with claim 15 comprising a gas removal apparatus in accordance with claim 11 and a flue gas outlet fluidly connected to supply flue gas directly from the combustion apparatus as a source gas stream to the removal apparatus.

17. A method of regeneration of capture medium rich in a captured target gas and recovery of captured gas therefrom comprising the steps of:
heating a target gas rich capture medium and thereby causing captured gas to dissociate into a gas rich vapour phase;
compressing the vapour phase and using the compressed vapour as a first source of thermal energy for heating the capture medium;
additionally taking a supply of cold reheat (CRH) steam from a thermal power plant, extracting work therefrom by passing the cold reheat steam through a back pressure turbine so as to drive a compressor to compress the said vapour phase and reducing the pressure of the CRH steam, and using the resultant lower pressure steam as a further source of thermal energy for heating the capture medium.

18. A method in accordance with claim 17 comprising passing the gas rich capture medium through a regeneration apparatus in accordance with claim 1 having a heating means to heat the gas rich capture medium and thereby cause captured gas to dissociate into a gas rich vapour phase;
wherein the compressed vapour is used to supply thermal energy to the heating means; and
wherein the resultant lower pressure steam is passed to the heating means as a further source of thermal energy therefor.

19. A method for the removal and recovery of a target gas from a gas stream which comprises the steps of: capturing a target gas from a source gas stream into a suitable capture medium by passing the source gas stream through lean capture medium so as to cause a target gas component of the gas stream to associated with the capture medium, drawing off the resultant target gas rich capture medium; processing the target gas rich capture medium in accordance with the method of claim 17.

20. A method of removal and recovery for sequestration of CO2 from a flue gas stream such as a thermal power plant flue gas stream comprising the method of claim 19 performed on a source gas stream comprising such a flue gas.
